(19) United States
(12) Patent Application Publication
(10) Pub. No.: US 2009/0087100 A1
(43) Pub. Date: Apr. 2, 2009

(54) TOP OF HEAD POSITION CALCULATING APPARATUS, IMAGE PROCESSING APPARATUS THAT EMPLOYS THE TOP OF HEAD POSITION CALCULATING APPARATUS, TOP OF HEAD POSITION CALCULATING METHOD AND RECORDING MEDIUM HAVING A TOP OF HEAD POSITION CALCULATING PROGRAM RECORDED THEREIN

(75) Inventor: Xuebin HU, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,454

(22) Filed: Sep. 29, 2008

(30) Foreign Application Priority Data
Sep. 28, 2007 (JP) 2007-253236

(51) Int. Cl. G06K 9/46

(52) U.S. Cl. 382/190

(57) ABSTRACT

Automatic detection of top of head positions of humans is enabled from within digital images even in cases that backgrounds are not monotonous. Face regions are detected from within input images. Detection ranges, within which tops of heads are searched for, are set based on the detected face regions. Hair regions are detected by extracting high frequency components from within the detection ranges. The positions of the tops of heads are calculated from the detected hair regions.

### BACKGROUND OF THE INVENTION

1. Field of the Invention

The present invention relates to a top of head position calculating process. Particularly, the present invention relates to a top of head position calculating apparatus suited for automatically detecting the positions of the tops of heads of humans in digital images, an image processing apparatus that employs the top of head position calculating apparatus, a top of head position calculating method, and a recording medium having a top of head is position calculating program recorded therein.

2. Description of the Related Art

Image processes, such as color tone correction, brightness correction, and image synthesis, have become easy to administer on digital images obtained by photography using digital still cameras, when photographing portraits of people. Therefore, various image processes are administered on photographed digital images such that they have favorable finishes, then the digital images are printed out.

There are empirically determined preferred compositions for portraits. When people are the subjects of photography, photography is performed with the faces of the people as reference points for compositional balance such that such preferred compositions are achieved. However, photography having ideal compositions cannot always be performed. Therefore, faces are automatically detected from within digital images which have been photographed with compositions that are not ideal, the images are automatically trimmed with the detected faces as reference points for compositional balance, then the trimmed images are printed out, such that the images achieve ideal compositions. However, there is a problem that optimal trimming processes cannot be administered unless the tops of heads and chins are accurately detected.

For this reason, methods for accurately detecting the positions of the tops of heads and methods for trimming images using data regarding detected top of head positions have been proposed.

For example, U.S. Patent Application Publication No. 20050147304 discloses a method, in which: a human face is detected; a top of head detecting window is set in the upper portion of the face; image features within the top of head detecting window are calculated in the vertical direction; and the position at which change in the image features is greater than or equal to a threshold value is calculated to be the top of the head. In addition, Japanese Unexamined Patent Publication No. 2002-042116 discloses a method, in which: a human face is detected; brightness variations between a background and the face are obtained; the top of the head of the detected human face is calculated based on the brightness variations; and a trimming process is administered.

However, in the aforementioned image processing methods for detecting the top of head positions, erroneous detection may occur in cases that backgrounds are not monotonous. This is because the colors and brightnesses of the backgrounds may be varied. In addition, the aforementioned methods assume that faces are facing straight forward toward the photographer. Therefore, there is a problem that stable detection performance cannot be obtained in cases that faces are not facing straight forward.

### SUMMARY OF THE INVENTION

The present invention has been developed in view of the foregoing circumstances. It is an object of the present invention to provide a top of head position calculating apparatus, an image processing apparatus that employs the top of head position calculating apparatus, a top of head position calculating method and a top of head position calculating program which has improved detection performance with regard to the tops of heads.

A top of head position calculating apparatus of the present invention comprises: a face detecting section that detects face regions, from within input images; a detection range setting section that sets detection ranges within which tops of heads are searched, based on the detected face regions; a hair region detecting section that detects hair regions by extracting high frequency components within the detection ranges; and a top of head calculating section that calculates the positions of tops of heads from the detected hair regions.

The “detection range setting section” sets the detection ranges, within which the tops of heads are searched for. The detection ranges may be set using the eyes and mouths within the detected face regions as references.

In the top of head position calculating apparatus of the present invention, the hair region detecting section may comprise: a brightness conversion processing section that converts the images within the detection ranges into brightness images; a high frequency component extracting section that extracts high frequency components from the brightness images by a filtering process; and a hair region setting section that sets the hair regions by administering emphasizing processes on the high frequency components. Further, the top of head calculating section may calculate the uppermost portions of the set hair regions as the top of head positions.

The top of head position calculating apparatus of the present invention may further comprise: a judging section that judges whether a hair region has been detected by the hair region detecting section; a horizontal brightness gradient calculating section that calculates rates of brightness variation by calculating horizontal brightness gradients from within the image portions of the detection ranges, in cases that the judging section judges that a hair region has not been detected by the hair region detecting section; a database having data that indicates statistical positional relationships among center positions between eyes, center positions of mouths, and tops of heads therein; a top of head position estimating section that calculates probabilities for the position of tops of heads, based on the data that indicates the statistical positional relationships and center positions between eyes and center positions of mouths within the detected face regions; and a top of head position calculating section that calculates the positions of tops of heads based on the results of calculation obtained by the horizontal brightness gradient calculating section and the top of head position estimating section.

The “database” may have data that represents statistical positional relationships constituted by ratios of distances between the center position between eyes and center positions of mouths, and distances between the centers of mouths and the positions of the tops of heads, from among a plurality of color images that include faces.

An image processing apparatus of the present invention comprises: a top of head position calculating apparatus of the present invention; a chin position calculating section that calculates the positions of the chin, based on the faces detected by the face detecting section; and a trimming section that determines ranges to be trimmed within the input color images, based on the positions of tops of heads calculated by the top of head position calculating apparatus and the positions of chins calculated by the chin position calculating section, and trims the color images.

A top of head position calculating method of the present invention comprises the steps of: detecting face regions from within input images; setting detection ranges within which tops of heads are searched, based on the detected face regions; detecting hair regions by extracting high frequency components within the detection ranges; and calculating the positions of tops of heads from the detected hair regions.

A top of head position calculating program of the present invention causes a computer to execute the functions of: detecting face regions from within input images; setting detection ranges within which tops of heads are searched, based on the detected face regions; detecting hair regions by extracting high frequency components within the detection ranges; and calculating the positions of tops of heads from the detected hair regions.

According to the top of head position calculating apparatus, the image processing apparatus that employs the top of head position calculating apparatus, the top of head position calculating method, and the top of head position calculating program of the present invention, hair regions are detected by extracting high frequency components, and the tops of heads are calculated from the detected hair regions. Therefore, top of head positions can be accurately detected even in the case that backgrounds are not monotonous.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object, and executable code, and can be in any language, including higher level languages, assembly language, and machine language.

### BRIEF DESCRIPTION OF THE DRAWINGS

FIG. 1 is a schematic block diagram that illustrates the construction of a top of head position calculating apparatus according to a first embodiment of the present invention.

FIG. 2 is a flow chart that illustrates the processes performed by the top of head position calculating apparatus of the first embodiment.

FIGS. 3A, 3B, 3C, and 3D are diagrams that illustrate the steps involved in extracting a hair region from a face region.

FIG. 4 is a schematic block diagram that illustrates the construction of a top of head position calculating apparatus according to a second embodiment of the present invention.

FIG. 5 is a flow chart that illustrates the processes performed by the top of head position calculating apparatus of the second embodiment.

FIGS. 6A, 6B, and 6C illustrate an example of an image in which a hair region is not accurately detected.

FIGS. 7A, 7B, and 7C illustrate an example of an image in which a hair region is accurately detected.

FIG. 8 is a flow chart that illustrates the processes of a second technique employed by the top of head position calculating apparatus of the second embodiment.

FIGS. 9A, 9B, and 9C illustrate an example of an image for which a horizontal direction histogram is generated and a maximum value is generated.

FIG. 10 is a schematic block diagram of an image processing apparatus according to a third embodiment of the present invention.

### BEST MODE FOR CARRYING OUT THE INVENTION

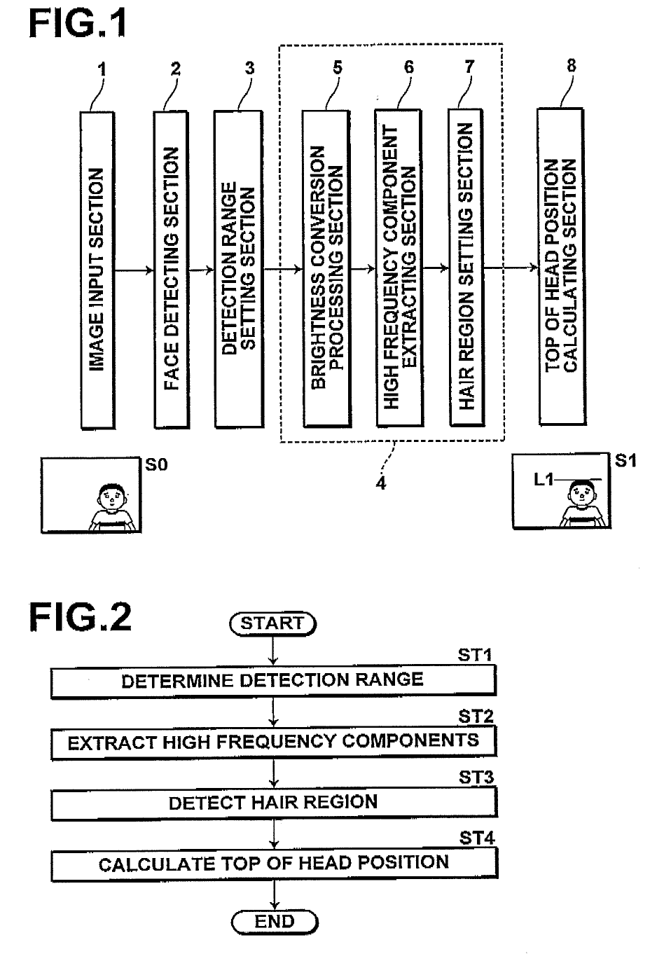

Hereinafter, a first embodiment of the present invention will be described. FIG. 1 is a schematic block diagram that illustrates the construction of a top of head position calculating apparatus according to the first embodiment of the present invention. As illustrated in FIG. 1, the top of head position calculating apparatus of the first embodiment is equipped with: an image input section 1 that receives input of image data sets S0 that represent images including faces; a face detecting section 2 that detects face regions from within images S0 represented by the image data sets S0 (hereinafter, image data sets and images will be denoted by the same reference characters); a detection range setting section 3 that sets detection ranges, within which tops of heads are searched for, based on the detected face regions; a hair region detecting section 4 that detects hair regions by extracting high frequency components from within the detection ranges; and a top of head position calculating section 8 that calculates the positions of the tops of heads from the detected hair regions.

Image S1 of FIG. 1 illustrates a horizontal line L1 which is drawn across a top of head position calculated by the top of head position calculating section 8. In the case that a monitor or the like is connected to the top of head position calculating apparatus, it is possible to display the horizontal line L1.

The image input section 1 is a media drive that reads out the images S0 from media having the images S0 recorded therein, interfaces that receive input of the images S0, which are transmitted via networks, or the like. Note that the images S0 may be images which have been obtained by imaging devices such as digital cameras, or images which have been obtained by photoelectric readout of images recorded on film or prints.

The face detecting section 2 administers a process that automatically detects face regions from within the images S0, based on one of: position, size, facing direction, inclination, chroma, and hue, which are evaluation values that represent the likelihood that regions within images are face regions.

The method disclosed in U.S. Patent Application Publication No. 20060133672 (hereinafter, referred to as Reference Document 1) may be employed, for example. In this method, known techniques such as movement vectors and feature detection, or a machine learning technique based on Adaboost is utilized to track faces. Adaboost is a technique in which learning data is continuously renewed at each re-sampling operation, to create machines, then the machines are weighted and combined to form an integrated learning machine. For example, an average frame model may be fitted into an actual image of a face, and the positions of landmarks (eyes and mouth, for example) within the average frame model may be moved to match the positions of corresponding landmarks which have been detected in the image of the face, thereby deforming the average frame model to construct a frame model of the face. Classifiers and classifying conditions for each landmark are obtained by learning brightness profiles of points within a plurality of sample images, which are known to be of predetermined landmarks, and brightness profiles of points within a plurality of sample images, which are known not to be of predetermined landmarks. The classifiers and classifying conditions are employed to detect points within the image of the face that represent the landmarks. Alternatively, the method disclosed in Japanese Unexamined Patent Publication No. 2004-334836 (hereinafter, referred to as Reference Document 2) may be employed. This method utilizes a characteristic portion extraction technique, in which: image data sets of a predetermined size are cut out from a target image data set; and each cut out image data set is compared against image data sets representing characteristic portions; to detect whether images of characteristic portions are present within the target image. Note that faces of animals may also be detected as specific subjects in addition to human faces, as disclosed in Japanese Unexamined Patent Publication No. 2007-011970 (hereinafter, referred to as Reference Document 3).

The detection range setting section 3 sets rectangular detection ranges above mouths within face regions detected by the face detecting section 2, based on the eyes and mouths included in the detected face regions.

The hair region detecting section 4 extracts high frequency components from within the detection ranges set by the detection range setting section 3, to detect hair regions. The hair region detecting section 4 is equipped with: a brightness conversion processing section 5 that converts the images within the detection ranges into brightness images; a high frequency component extracting section 6 that extracts high frequency components from the brightness images by a filtering process; and a hair region setting section 7 that sets the hair regions by administering emphasizing processes on the high frequency components.

The top of head position calculating section 8 calculates the uppermost portions of the hair regions detected by the hair region detecting section 4 as the positions of the tops of heads.

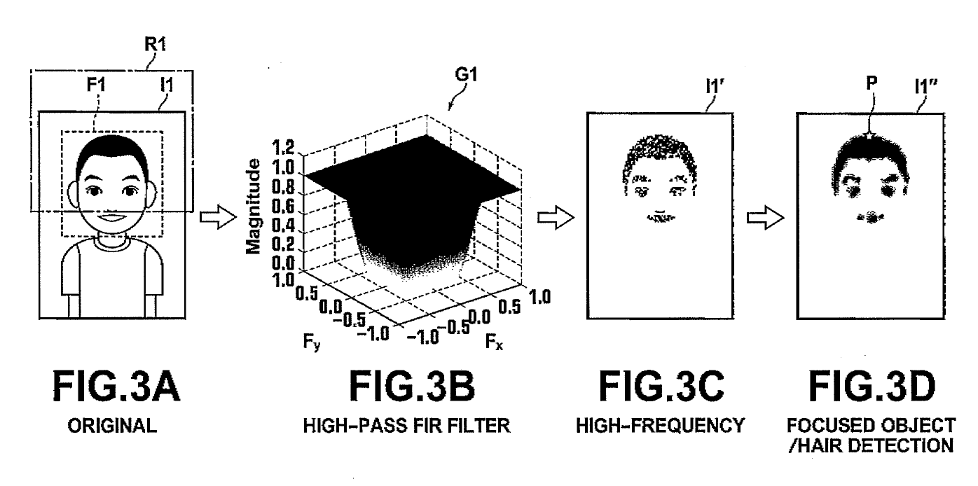

Next, the processes performed by the top of head position calculating apparatus of the first embodiment will be described. FIG. 2 is a flow chart that illustrates the processes performed by the top of head position calculating apparatus of the first embodiment. The processes are initiated when an image data set S0 is read out by the image input section 1. The face detecting section 2 detects a face region from within the image S0, and the detection range setting section 3 sets a detection range assumed to include a hair region, based on the eyes and mouth of the detected face region (step ST1). For example, the region labeled F1 in FIG. 3A is the detected face region, and the region labeled R1 is the rectangular region set as the detection range. After detecting the eyes and the mouth, the detection range is set above the mouth, because hair regions are above mouths. Next, the brightness conversion processing section 5 converts the portion of the image within the detection range set by the detection range setting section 3 into a brightness image. The high frequency component extracting section 6 extracts high frequency components from the converted brightness image by a filtering process (step ST2). Graph G1 of FIG. 3B illustrates an example in which high frequency components are detected by a High Pass FIR filter, as an example of a filtering process. Image I1′ of FIG. 3C illustrates an example of high frequency components which have been extracted by the High Pass FIR filter. Because hair regions are constituted by many fine hairs, hair regions include many high frequency components as image data, and this fact is utilized.

The hair region detecting section 4 detects a hair region by administering an emphasizing process on the extracted high frequency components (step ST3). Image I1″ of FIG. 3D is an image which has been output after a closing process, which is an example of an emphasizing process, is administered on the image I1′. The top of head position calculating section 8 calculates the maximum value at the upper edge of the hair region as a top of head position (step ST4). Point P in FIG. 3D is an example of a calculated top of head position.

Next, a second embodiment of the present invention will be described.

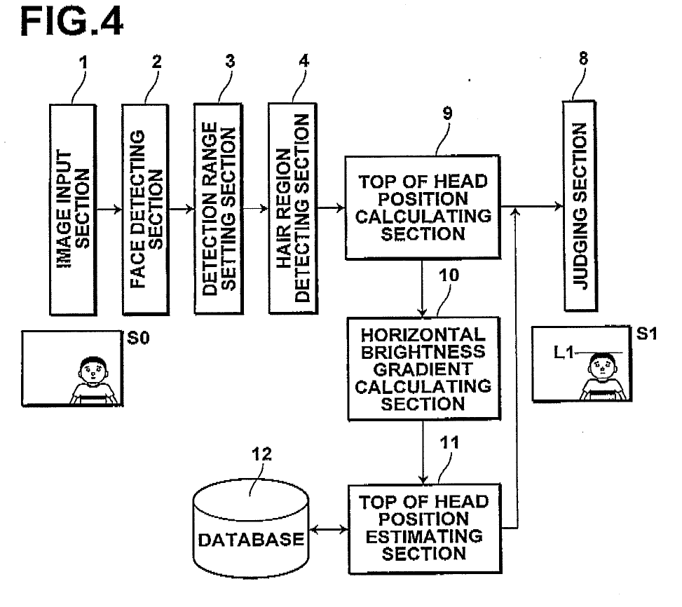

FIG. 4 is a schematic block diagram that illustrates the construction of a top of head position calculating apparatus according to the second embodiment of the present invention, which includes a judging section 9 and the like.

The judging section 9 judges whether a hair region has been detected by the hair region detecting section 4.

A horizontal brightness gradient calculating section 10 calculates rates of brightness variation by calculating horizontal brightness gradients from within the image portions of the detection ranges set by the detection range setting section 3.

A database 12 has data that indicates statistical positional relationships among center positions between eyes, center positions of mouths, and tops of heads therein. For example, the database may have statistical top of head position data indicating statistical positional relationships constituted by ratios of distances between the center position between eyes and center positions of mouths, and distances between the centers of mouths and the positions of the tops of heads, obtained from approximately 950 images.

The top of head position estimating section 11 calculates probabilities for the positions of tops of heads, based on the statistical top of head position data obtained from the database 12 and center positions between eyes and center positions of mouths within face regions detected by the face detecting section 2.

The top of head position calculating section 8 calculates the positions of the tops of heads based on the results of calculation obtained by the horizontal brightness gradient calculating section 10 and the top of head position estimating section 11, in the case that the judging section 9 judges that a hair region has not been detected.

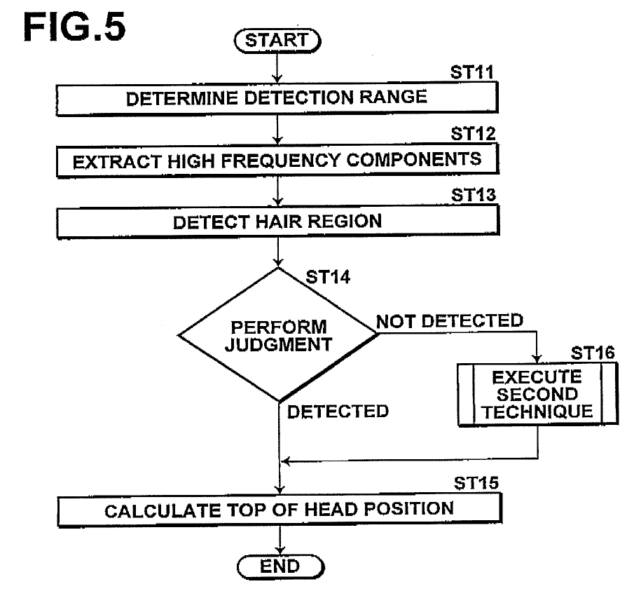

Next, the processes performed by the top of head position calculating apparatus of the second embodiment will be described. FIG. 5 is a flow chart that illustrates the processes performed by the top of head position calculating apparatus of the second embodiment.

The processes are initiated when an image data set S0 is read out by the image input section 1. The face detecting section 2 detects a face region from within the image S0, and the detection range setting section 3 sets a detection range (the aforementioned rectangular region) assumed to include a hair region, using the eyes and mouth of the detected face region as reference points (step ST11). After detecting the eyes and the mouth, the detection range is set above the mouth, because hair regions are above mouths. Next, the brightness conversion processing section 5 converts the portion of the image within the detection range set by the detection range setting section 3 into a brightness image. The high frequency component extracting section 6 extracts high frequency components from the converted brightness image by a filtering process (step ST12). Because hair regions are constituted by many fine hairs, hair regions include many high frequency components as image data. This fact is utilized to extract high frequency components as described previously, and a hair region is detected from high frequency components greater than or equal to a predetermined value (step ST13).

The judging section 9 uses the hair region extracted by the high frequency component extracting section 6 or the hair region detecting section 7 as a mask, and fits a line to the upper edge of the mask. Differences between the line and the upper edge of the mask are calculated (step ST14). In the case that the differences are great, it is judged that the extracted hair region is a hair region. In the case that the differences are small, the extracted hair region is judged not to be a hair region.

It cannot be thought that the upper edge of the hair region is a straight line, because human heads are rounded at the tops thereof.

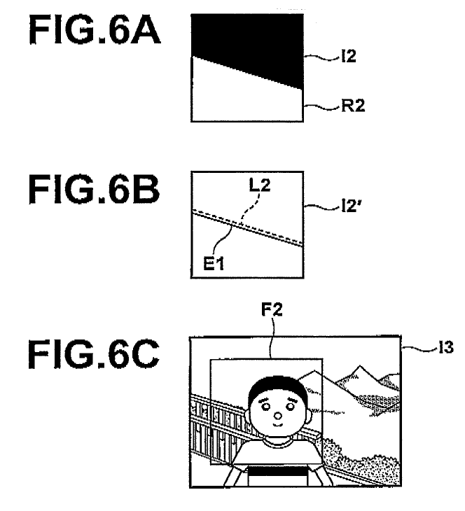

For example, FIGS. 6A through 6C illustrate a case in which a hair region was not accurately detected. In this case, a wooden fence is included in an image I3. The wooden fence includes many high frequency components, and therefore was erroneously extracted as a hair region. FIG. 6A illustrates the mask obtained by the high frequency components which are extracted from a face region F2 of image I3 of FIG. 6C. The region which is utilized as a mask is R2. If a line L2 is fitted to the upper edge E1 of the mask of FIG. 6B, there is little difference between the line L2 and the upper edge E1. Therefore, the mask is judged not to be a hair region.

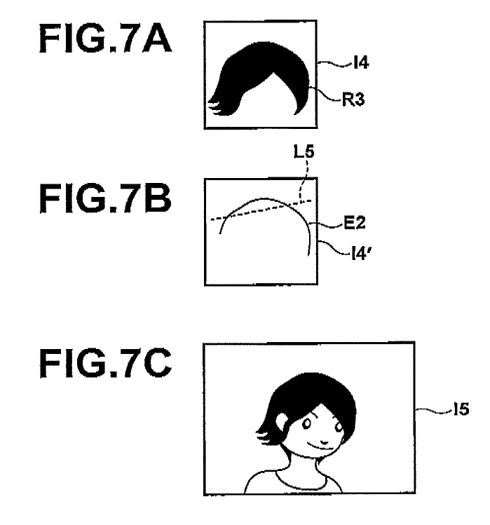

On the other hand, FIGS. 7A through 7C illustrate a case in which a hair region was accurately detected. For example, FIG. 7A illustrates a mask obtained from image I5 of FIG. 7C. The region which is utilized as a mask is R3. When a line L5 is fitted to the upper edge E2 of the mask of FIG. 7B, there are great differences between the line L5 and the edge E2. Therefore, the mask is judged to be a hair region.

In the case that the judging section 9 judges that the hair region has been detected by the hair region detecting section 4, the top of head position is calculated by the mention described previously in the first embodiment (step ST15).

On the other hand, in the case that the judging section 9 judges that a hair region has not been detected by the hair region detecting section 4, the top of head position is calculated by a second technique (step ST16).

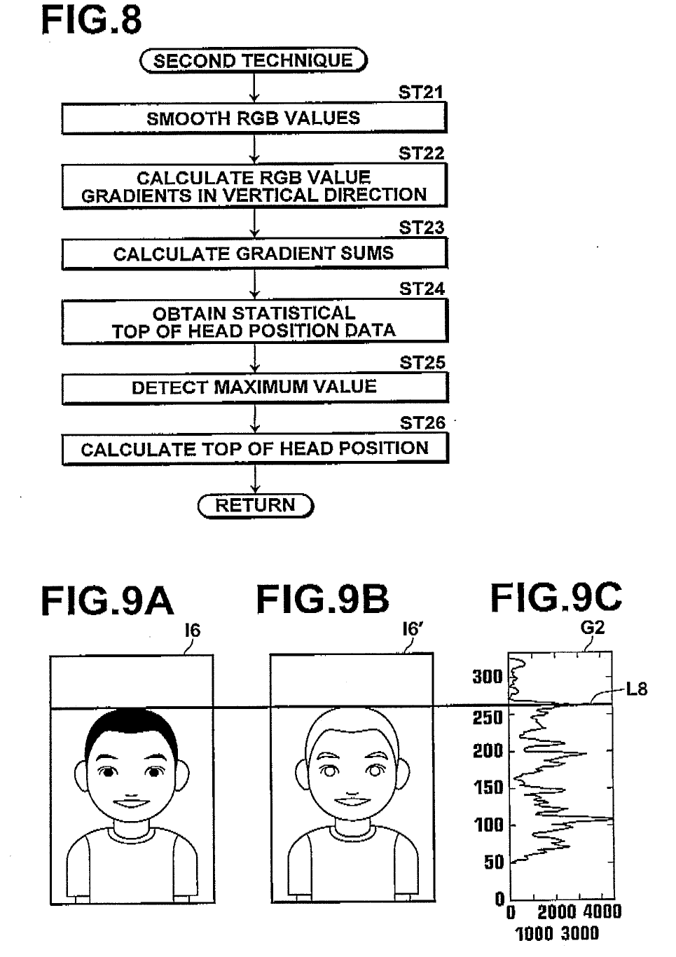

FIG. 8 is a flow chart that illustrates the processes of the second technique.

The horizontal brightness gradient calculating section 10 smoothes the RGB values of the portion of the image included in the detection range set by the detection range setting section 3 (step ST21). Next, gradients of the RGB value are calculated in the vertical direction (step ST22). For example, image I6′ of FIG. 9B is an image in which gradients of the RGB value have been calculated in the vertical direction from image I6 of FIG. 9A. Next, the horizontal brightness gradient calculating section 10 calculates sums of the gradients in the vertical direction (step ST23). For example, a horizontal direction histogram (illustrating rates of brightness variation) having brightness values as the horizontal axis, and the sums of gradients in the vertical direction as the vertical axis is generated, such as the graph G2 of FIG. 9C.

The top of head position estimating section 11 obtains the statistical top of head position data from the database 12 (step ST24). Then, the top of head position estimating section 11 calculates probabilities for the positions of tops of heads based on the obtained statistical top of head position data and the center positions between eyes and center positions of mouths within the detected face region. The probabilities for the positions of tops of heads are multiplied by the horizontal direction histogram, and the maximum value from among the products is detected (step ST25). Line L8 illustrated in FIG. 9 is a line which is synthesized with the horizontal direction histogram with the maximum calculated value as a reference.

The top of head position calculating section 8 calculates the position of the top of the head, based on the maximum value of the product of the probabilities calculated by the top of head position estimating section 11 and the horizontal direction histogram.

Next, a third embodiment of the present invention will be described.

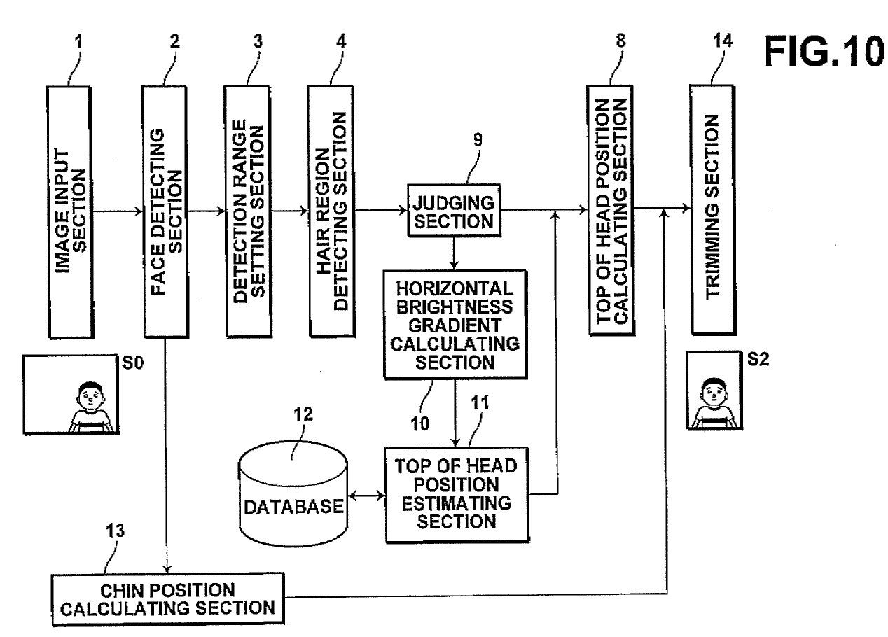

FIG. 10 is a schematic block diagram of an image processing apparatus according to the third embodiment of the present invention, which includes a chin position calculating section 13 and a trimming section 14.

Here, only components which are different from the top of head position calculating apparatuses of the first and second embodiments will be described. Components which are the same as those of the above embodiments will be denoted with the same reference numerals, and detailed descriptions thereof will be omitted.

The database 12 has data indicating the statistical positional relationships among the center positions between eyes, center positions of mouths, and positions of chins, in addition to the statistical top of head position data.

The chin position calculating section 13 calculates a reference line that connects the center position between the eyes and the center position of a mouth, which are included in a face region detected by the face detecting section 2. The chin position calculating section 13 obtains data indicating the statistical positional relationships among the center positions between eyes, center positions of mouths, and positions of chins from the database 12. The chin position calculating section 13 calculates a probability that the calculated reference line includes the position of a chin, based on the data that indicates the statistical positional relationships and the reference line. The chin position calculating section 13 calculates the probabilities of skin colored pixels being present on the reference line. The chin position calculating section 13 calculates the rates of brightness variations along the reference line. The chin position calculating section 13 calculates the position of the chin based on the combined results of the aforementioned calculations.

The trimming section 14 determines a range to be trimmed, based on the position of the chin calculated by the chin position calculating section 13 and the position of the top of the head calculated by the top of head position calculating section 8, then trims the image S0.

Image S2 of FIG. 10 is the result of determination of a range to be trimmed and a trimming operation, which are administered with respect to the image S0. In the case that a monitor or the like is connected to the image processing apparatus, it is possible to display the results of trimming for confirmation by users.

It is possible to install a program that causes a computer to execute the functions of the top of head calculating apparatus and the image processing apparatus of the present invention in a personal computer. In this case, it is possible for the personal computer to perform calculation of the top of head positions and trimming as described in the embodiments above.

In addition, it is possible to incorporate the top of head position calculating apparatus and the image processing apparatus of the present invention into an imaging device. In this case, the calculation results of top of head positions and results of trimming may be confirmed by a user, using a monitor or the like provided on the imaging device.

What is claimed is:

1. A top of head position calculating apparatus, comprising:
a face detecting section that detects face regions, from within input images;
a detection range setting section that sets detection ranges within which tops of heads are searched, based on the detected face regions;
a hair region detecting section that detects hair regions by extracting high frequency components within the detection ranges; and
a top of head calculating section that calculates the positions of tops of heads from the detected hair regions.

2. A top of head position calculating apparatus as defined in claim 1, wherein:
the detection range setting section sets the detection ranges using the eyes and mouths within the detected face regions.

3. A top of head position calculating apparatus as defined in claim 2, wherein the hair region detecting section comprises:
a brightness conversion processing section that converts the images within the detection ranges into brightness images;
a high frequency component extracting section that extracts high frequency components from the brightness images by a filtering process; and
a hair region setting section that sets the hair regions by administering emphasizing processes on the high frequency components.

4. A top of head position calculating apparatus as defined in claim 3, wherein:
the top of head calculating section calculates the uppermost portions of the set hair regions as the top of head positions.

5. A top of head position calculating apparatus as defined in claim 1, further comprising:
a judging section that judges whether a hair region has been detected by the hair region detecting section;
a horizontal brightness gradient calculating section that calculates rates of brightness variation by calculating horizontal brightness gradients from within the image portions of the detection ranges, in cases that the judging section judges that a hair region has not been detected by the hair region detecting section;
a database having data that indicates statistical positional relationships among center positions between eyes, center positions of mouths, and tops of heads therein;
a top of head position estimating section that calculates probabilities for the position of tops of heads, based on the data that indicates the statistical positional relationships and center positions between eyes and center positions of mouths within the detected face regions; and
a top of head position calculating section that calculates the positions of tops of heads based on the results of calculation obtained by the horizontal brightness gradient calculating section and the top of head position estimating section.

6. An image processing apparatus, comprising:
a top of head position calculating apparatus according to claim 1;
a chin position calculating section that calculates the positions of the tops of heads, based on the faces detected by the face detecting section; and
a trimming section that determines ranges to be trimmed within the input color images, based on the positions of tops of heads calculated by the top of head position calculating section and the positions of chins calculated by the chin position calculating section, and trims the color images.

7. A top of head position calculating method, comprising the steps of;
detecting face regions from within input images;
setting detection ranges within which tops of heads are searched, based on the detected face regions;
detecting hair regions by extracting high frequency components within the detection ranges; and
calculating the positions of tops of heads from the detected hair regions.

8. A recording medium having a program recorded therein that causes a computer to execute the functions of:
detecting face regions from within input images;
setting detection ranges within which tops of heads are searched, based on the detected face regions;
detecting hair regions by extracting high frequency components within the detection ranges; and
calculating the positions of tops of heads from the detected hair regions.
